(19) United States
(12) Patent Application Publication
(10) Pub. No.: US 2010/0082461 A1
(43) Pub. Date: Apr. 1, 2010

(54) ASSOCIATING A FOREIGN CURRENCY WITH AN ACCOUNTING OBJECT

(75) Inventors: Michelle Bacigalupi, San Carlos, CA (US); Venkatesan Murugesan, San Jose, CA (US); Pranay Kapadia, Santa Clara, CA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/240,567

(22) Filed: Sep. 29, 2008

(51) Int. Cl. G06Q 10/00; G06Q 40/00

(52) U.S. Cl. 705/30

(57) ABSTRACT

Some embodiments of the present invention provide a system that automatically associates a foreign currency with an accounting object. First, a name is received from a user. Next, an association between the name and the foreign currency is determined, wherein the foreign currency is different from a home currency. Then, the accounting object is automatically associated with the foreign currency associated with the name.

### BACKGROUND

### RELATED ART

The present invention generally relates to computer-based techniques to facilitate accounting.

Companies that conduct business with entities in foreign countries may have to account for their transactions in one or more foreign currencies. However, accounting for different transactions in multiple foreign currencies typically requires the creation of one or more accounts for each foreign currency in which a transaction is conducted. The process of creating the foreign-currency account before a transaction can be entered is not only time consuming and cumbersome, but is also a potential source of error if the wrong currency account is selected for a transaction.

### SUMMARY

Some embodiments of the present invention provide a system that automatically associates a foreign currency with an accounting object. First, a name is received from a user. Next, an association between the name and the foreign currency is determined, wherein the foreign currency is different from a home currency. Then, the accounting object is automatically associated with the foreign currency associated with the name.

In some embodiments, determining the association between the name and the foreign currency includes determining an association between the name and an account which is associated with the foreign currency.

In some embodiments, automatically associating the accounting object with the foreign currency includes generating the accounting object.

In some embodiments, the accounting object includes at least one of: an item, a transaction form, an accounts receivable account, and an accounts payable account.

In some embodiments, determining the association between the name and the foreign currency includes determining the association based on information associated with the name.

In some embodiments, the information associated with the name includes at least one of: an address, a phone number, an item, and a currency of a price level.

In some embodiments, automatically associating the accounting object with the foreign currency includes displaying a value associated with the accounting object, wherein the value is displayed in the foreign currency, and wherein an identifier associated with the foreign currency is also displayed.

Some embodiments further include generating a transaction form, wherein one or more values on the transaction form associated with the name are displayed in the foreign currency.

Some embodiments further include receiving a value from the user and associating the value with the foreign currency.

Some embodiments further include converting a value associated with the accounting object from at least one of: the foreign currency to the home currency, and the home currency to the foreign currency.

### BRIEF DESCRIPTION OF THE FIGURES

FIG. 1 depicts a computer system that automatically associates a foreign currency with an accounting object in accordance with some embodiments of the present invention.

FIG. 2A depicts a form for associating a name with a currency in accordance with some embodiments of the present invention.

FIG. 2B depicts a form that allows a user to make an inactive currency active in accordance with some embodiments of the present invention.

FIG. 2C depicts an estimate form generated in accordance with some embodiments of the present invention.

FIG. 3 depicts an invoice form generated in accordance with some embodiments of the present invention.

FIG. 4 depicts a customer-payment form generated in accordance with some embodiments of the present invention.

FIG. 5 depicts a vendor-payment form generated in accordance with some embodiments of the present invention.

FIG. 6 presents a flowchart illustrating the process of associating an accounting object with a foreign currency in accordance with some embodiments of the present invention.

FIG. 7 presents a flowchart illustrating the process of associating an item with a foreign currency price level in accordance with some embodiments of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

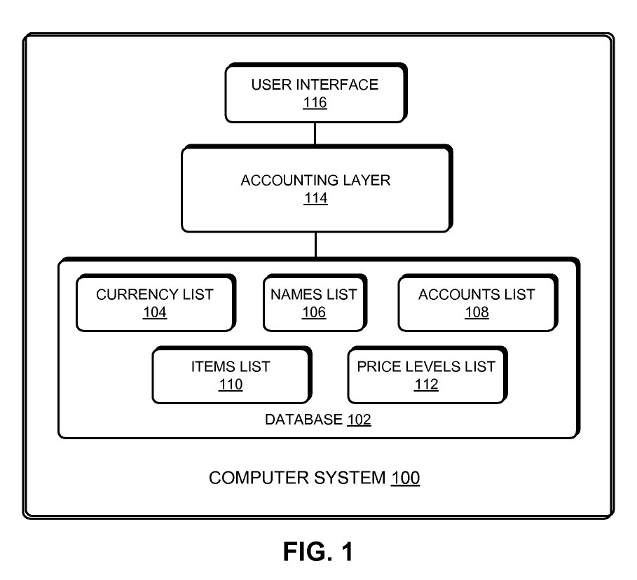

FIG. 1 depicts a computer system that automatically associates a foreign currency with an accounting object in accordance with some embodiments of the present invention. Computer system 100 includes database 102 which contains currency list 104, names list 106, accounts list 108, items list 110, and price levels list 112. Furthermore, computer system 100 includes accounting layer 114, and user interface 116.

Computer system 100 can include but is not limited to a personal computer (PC); a server; a client computer communicating with a server through a network such as the Internet; a hand-held computer; a personal digital assistant (PDA), a cell phone, or any other computation system or combination of systems.

Database 102 can be implemented in any technology now known or later developed, and in any combination of hardware and software. Note that in some embodiments, database 102 is stored on one or more hard drives. Furthermore, database 102 includes currency list 104, names list 106, accounts list 108, items list 110, and price levels list 112. Each of these components in database 102 will be described in more detail below: Currency list 104 includes a list of currencies and may include a complete list of currencies used throughout the world. Names list 106 includes a list of names used in transactions, as described below, and can include but is not limited to customer names, vendor names, employee names, or any other name that may be a party to a transaction. Accounts list 108 includes accounts used in used in transactions, as described below, and can include but is not limited to accounts receivable and accounts payable. In some embodiments, one or more of the accounts in accounts list 108 are in one or more of the currencies in currency list 104. Items list 110 includes items that may be sold in transactions as described below. Price levels list 112 includes prices in one or more currencies in currency list 104 for items in items list 110.

During system operation, accounting layer 114 receives input from user interface 116 and generates a transaction using information from database 102. Examples of transactions include but are not limited to an invoice, an estimate, a bill, a payment, or any other transaction that includes the denomination of one or more numbers in one or more currencies.

User interface 116 receives input from a user, transmits the input to accounting layer 114, receives information from accounting layer 114, and renders the information into a form suitable to convey it to a user. User interface 116 can include but is not limited to one or more of: a display; a touch-screen; a keyboard; and a mouse, or any other pointing device.

The operation of some embodiments of the present invention will be described below. In some embodiments, a user requests the creation of an estimate form through user interface 116. The request is transmitted by user interface 116 to accounting layer 114. Then, accounting layer 114 generates the estimate form and requests data from database 102 to fill out the form. The estimate form is then displayed on user interface 116. The user then inputs the name of the customer in the estimate form using user interface 116. Accounting layer 114 then searches for the name of the customer in names list 106 in database 102.

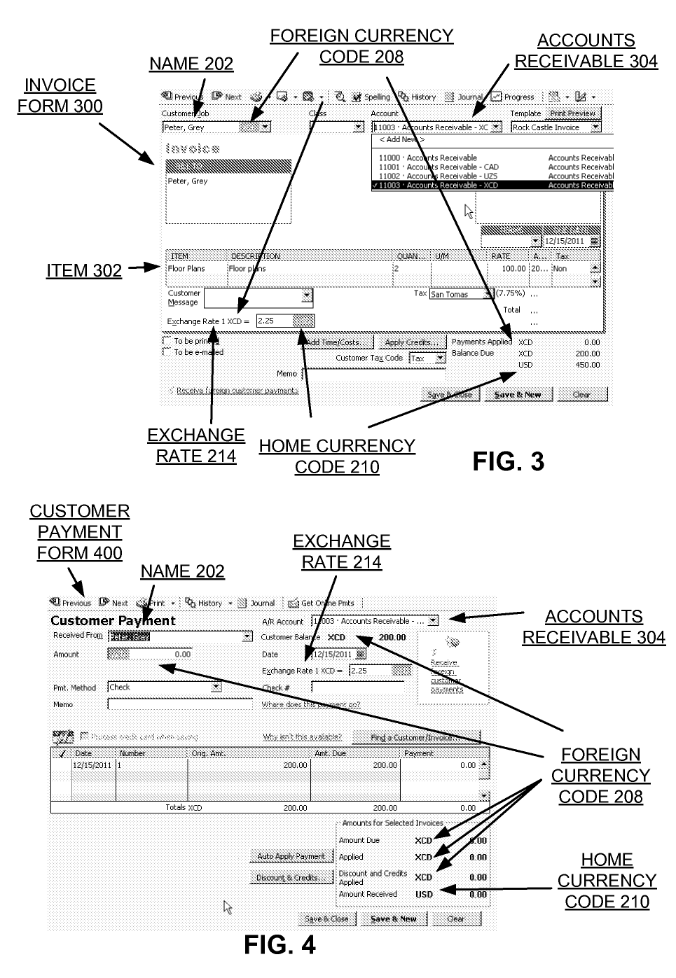

We first discuss embodiments in which the name received from the user is not found in names list 106 in database 102. Embodiments in which the name received from the user is found in names list 106 will be discussed below with reference to FIGS. 3-5.

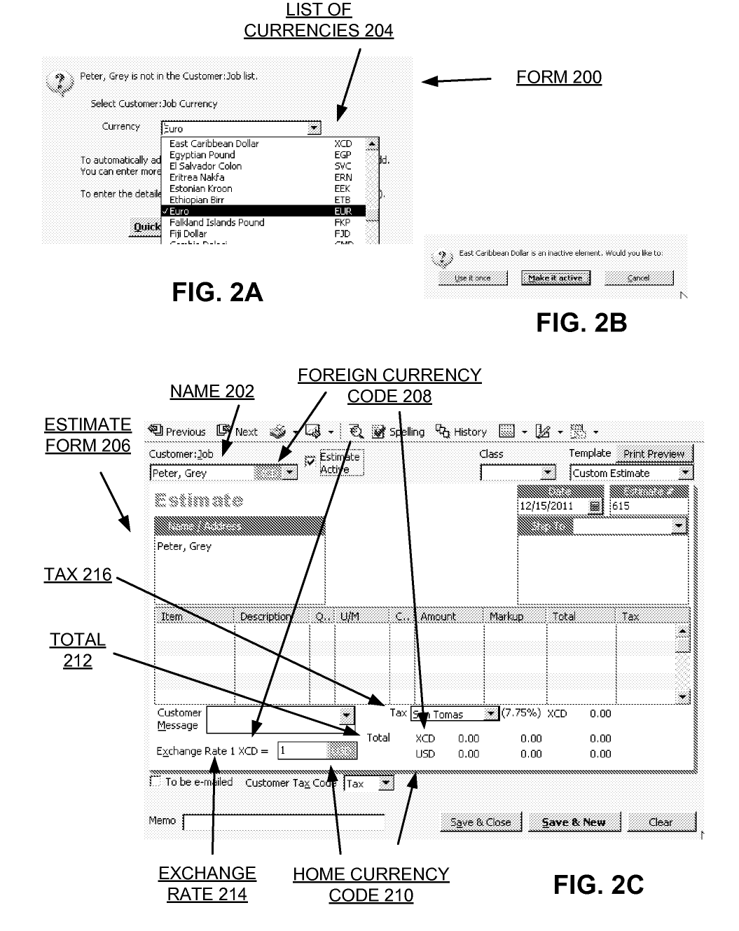

When the name is not found in database 102, accounting layer 114 sends this information to user interface 116 and requests that the user associate a currency with the name. FIG. 2A depicts a form displayed by user interface 116, in some embodiments, that allows a user to associate a currency with a name. In the example of FIG. 2A, form 200 notifies the user that the name, Grey Peter, was not found in the names list 106 (specifically the “Customer: Job” list in names list 106). Then, using user interface 116, the user selects the currency to associate with the name. Note that list of currencies 204 includes currencies stored in currency list 104. In some embodiments, list of currencies 204 includes a list of the currencies that are commonly used by the user (“active” currencies). Also, note that in some embodiments, when the accounting system implemented in computer system 100 is originally set up, a “home” currency is selected as the default currency for the accounting system. For example, in the embodiments of FIGS. 2-5 the home currency is United States dollars (USD).

As depicted in FIG. 2B, the user selects a currency that is not commonly used (an “inactive” currency), the East Caribbean Dollar, represented by the three-letter currency code XCD. In this case, the user has the option of making the currency active or just using it once. The selected currency, XCD, is then transmitted from user interface 116 to accounting layer 114 and is associated with the name, Grey Peter, stored in names list 106. Since the selected currency is different from the home currency, the selected currency is called a “foreign” currency.

Note that in some embodiments, a currency can be associated with a name using other methods. In some embodiments, prior to requesting the creation of a transaction, a user enters one or more names through user interface 116 and associates each name with a currency. In some embodiments, a user enters a name and an address associated with the name, and a foreign currency is associated with the name based on the address. For example, a user may enter a customer name using a form displayed on user interface 116, and a Canadian address for the customer. When user interface 116 transmits this information to accounting layer 114, accounting layer 114 determines that the address is Canadian and associates the name with Canadian currency. In some embodiments, other information can be used to associate a name with a currency, including but not limited to a telephone number, or any other information entered by a user that can be used to infer the currency to associate with the name. Furthermore, in some embodiments, when a user requests the creation of a form, information entered into the form by the user is used to determine the currency to associate with the name. In some embodiments, the information entered into the form that can be used to infer the currency to associate with the name can include but is not limited to an item, the currency of a price level for an item, or any other information entered on a form that can be used to infer the currency to associate with the name.

Continuing with the example: after the name entered by the user is associated with the selected foreign currency, accounting layer 114 automatically generates one or more accounting objects associated with the foreign currency, including but not limited to one or more of: an accounts receivable in the foreign currency; an accounts payable in the foreign currency; an item; and a transaction form based on the foreign currency and/or including values denominated in the foreign currency. In some embodiments, the one or more new accounting objects are stored in accounts list 108 or elsewhere in database 102.

Then, when the accounting layer generates estimate form 206 as depicted in FIG. 2C, name 202 is displayed associated with foreign currency 208 in the upper left corner of estimate form 206. Additionally, note that estimate form 206 is generated so that the values of the items in the estimate and the tax are denominated in the foreign currency associated with name 202, while the total for the estimate is displayed in both the foreign currency and home currency. Furthermore, exchange rate 214 between the foreign currency and the home currency is displayed in the lower left-hand corner of estimate form 206. Note that, in general, once a name is associated with a foreign currency, any transaction form associated with the name will be generated so that values on the form such as item price levels and taxes are denominated in the foreign currency associated with the name. Note that in some embodiments, the foreign currency associated with name 202 can be altered by clicking on foreign currency code 208 to the right of name 202 using user interface 116 and selecting a different currency to associate with name 202 using a process similar to that described above with reference to FIGS. 2A & 2B.

FIG. 3 depicts another transaction form generated in accordance with some embodiments of the present invention. In the example of FIG. 3, a user requests the creation of invoice form 300 using user interface 116. User interface 116 transmits the request to accounting layer 114, and accounting layer 114 generates the form and displays it on user interface 116. The user then enters name 202 in invoice form 300 using user interface 116. Name 202 is then transmitted by user interface 116 to accounting layer 114. Accounting layer 114 then searches names list 106 for name 202. Since name 202 was already entered into names list 106 and associated with a foreign currency (XCD) in foreign currency list 104, accounting layer 114 uses the associated foreign currency to generate portions of invoice form 300. As depicted in invoice form 300, foreign currency code 208 is displayed with name 202 in the field in the upper left-hand corner of invoice form 300. Additionally, accounts receivable 304 in the foreign currency, which was automatically generated when the foreign currency was associated with name 202, is displayed as the account for invoice form 300. Furthermore, the balance due is also shown in the home currency, and exchange rate 214 between the foreign currency and the home currency is also displayed. Additionally, item 302 is automatically priced in the foreign currency. In some embodiments, if item 302 is associated with a price level in the foreign currency associated with name 202, then the foreign currency price level is used for item 302. If there is no price level in the foreign currency associated with item 302, then the price level in invoice form 300 is determined using the price level of item 302 in the home currency and converting the price level to the foreign currency using exchange rate 214.

FIG. 4 depicts a customer payment form generated in accordance with embodiments of the present invention. When the user requests the generation of customer payment form 400 and enters name 202, customer payment form 400 is generated using the associated foreign currency, XCD. As depicted in FIG. 4, accounts receivable 304 in the foreign currency is associated with customer payment form 400. Additionally, values on customer payment form 400 are automatically denominated in the foreign currency associated with name 202 as shown by foreign currency code 208 on customer payment form 400. Furthermore, exchange rate 214 between the home currency and the foreign currency is displayed, and the amount received is shown denominated in the home currency as shown by home currency code 210.

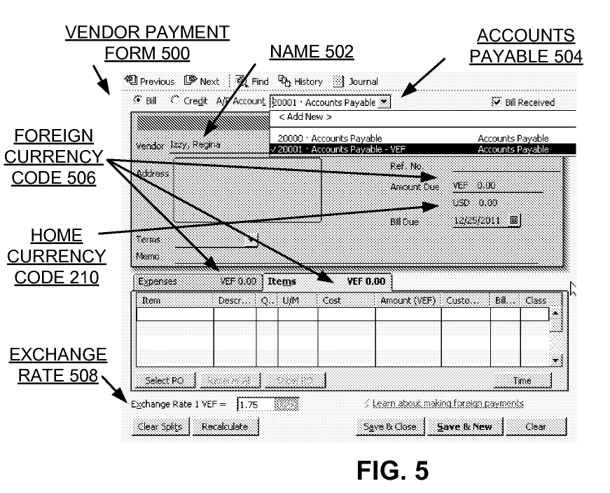

FIG. 5 depicts a vendor payment form generated in accordance with embodiments of the present invention. When the user request the generation of vendor payment form 500 and enters name 502, vendor payment form 500 is generated using the foreign currency associated with name 502, the Venezuelan Bolivares Fuertes (VEF). As depicted in FIG. 5, accounts payable 504 in the foreign currency is associated with vendor payment form 500. Note that in some embodiments, accounts payable 504 in VEF was generated when name 502 was associated with the foreign currency VEF. Additionally, values on vendor payment form 500 are automatically denominated in the foreign currency associated with name 502, as shown by foreign currency code 506 on vendor payment form 500. Furthermore, exchange rate 508 between the home currency and the foreign currency is displayed, and the amount due is shown denominated in the home currency as shown by home currency code 210.

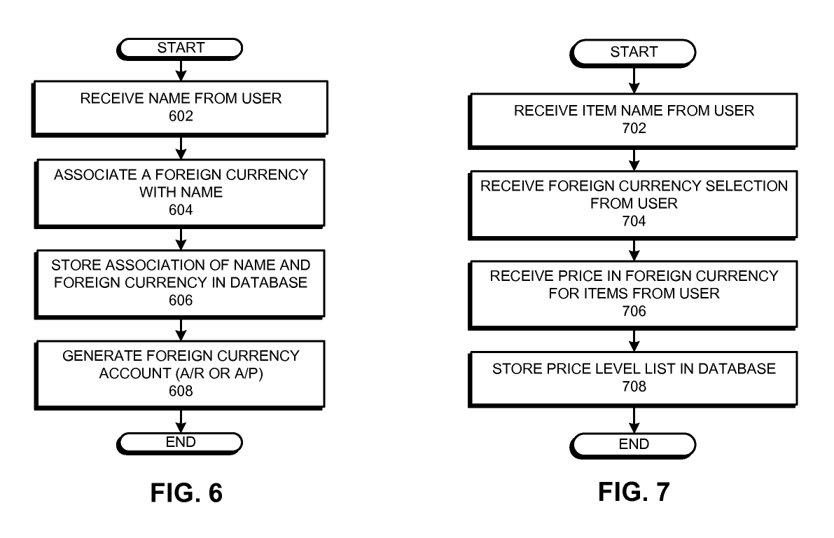

FIG. 6 presents a flowchart illustrating the process of associating an accounting object with a foreign currency in accordance with some embodiments of the present invention. First, a name is received from a user (step 602). The name can be a customer name, vendor name, employee name, or any other name that is or may be a party to a transaction. Then, a foreign currency is associated with the name (step 604). Next, the association between the name and the foreign currency is stored in a database (step 606). Then, accounting objects associated with the foreign currency are automatically generated (step 608). In some embodiments, the accounting objects include but are not limited to one or more of an accounts receivable in the foreign currency, and an accounts payable in the foreign currency.

FIG. 7 presents a flowchart illustrating the process of associating an item with a foreign currency price level in accordance with some embodiments of the present invention. First, an item name is received from a user (step 702). Then, a foreign currency is selected by the user (step 704). Next, a price in the foreign currency for the item is received from the user (step 706). Then the price level for the item in the foreign currency is stored in a database (step 708). Note that an item price level can be independently set in the home currency and in multiple foreign currencies. As discussed with reference to FIG. 3, an item price level set in a foreign currency using the above process may be automatically used when entering an item in a transaction form such as invoice form 300 if the foreign currency of the price level matches the foreign currency associated with the name on transaction form.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for automatically associating a foreign currency with an accounting object, the method comprising:
receiving a name from a user;
determining an association between the name and the foreign currency, wherein the foreign currency is different from a home currency; and
automatically associating the accounting object with the foreign currency associated with the name.

2. The method of claim 1, wherein determining the association between the name and the foreign currency includes:
determining an association between the name and an account which is associated with the foreign currency.

3. The method of claim 1, wherein automatically associating the accounting object with the foreign currency includes generating the accounting object.

4. The method of claim 1, wherein the accounting object includes at least one of:
an item;
a transaction form;
an accounts receivable account; and
an accounts payable account.

5. The method of claim 1, wherein determining the association between the name and the foreign currency includes determining the association based on information associated with the name.

6. The method of claim 5, wherein the information associated with the name includes at least one of:
an address;
a phone number;
an item; and
a currency of a price level.

7. The method of claim 1, wherein automatically associating the accounting object with the foreign currency includes:
displaying a value associated with the accounting object wherein the value is displayed in the foreign currency, and wherein an identifier associated with the foreign currency is also displayed.

8. The method of claim 1, further including generating a transaction form wherein one or more values on the transaction form associated with the name are displayed in the foreign currency.

9. The method of claim 1, further including receiving a value from the user and associating the value with the foreign currency.

10. The method of claim 1, further including converting a value associated with the accounting object from at least one of:
the foreign currency to the home currency; and
the home currency to the foreign currency.

11. A computer-readable storage medium storing instructions that when executed by a computer cause the computer to perform a method for automatically associating a foreign currency with an accounting object, the method comprising:
receiving a name from a user;
determining an association between the name and the foreign currency, wherein the foreign currency is different from a home currency; and
automatically associating the accounting object with the foreign currency associated with the name.

12. The computer-readable storage medium of claim 11, wherein determining the association between the name and the foreign currency includes:
determining an association between the name and an account which is associated with the foreign currency.

13. The computer-readable storage medium of claim 11, wherein automatically associating the accounting object with the foreign currency includes generating the accounting object.

14. The computer-readable storage medium of claim 11, wherein the accounting object includes at least one of:
an item;
a transaction form;
an accounts receivable account; and
an accounts payable account.

15. The computer-readable storage medium of claim 11, wherein determining the association between the name and the foreign currency includes determining the association based on information associated with the name.

16. The computer-readable storage medium of claim 15, wherein the information associated with the name includes at least one of:
an address;
a phone number;
an item; and
a currency of a price level.

17. The computer-readable storage medium of claim 11, wherein automatically associating the accounting object with the foreign currency includes:
displaying a value associated with the accounting object wherein the value is displayed in the foreign currency, and wherein an identifier associated with the foreign currency is also displayed.

18. The computer-readable storage medium of claim 11, further including generating a transaction form wherein one or more values on the transaction form associated with the name are displayed in the foreign currency.

19. The computer-readable storage medium of claim 11, further including receiving a value from the user and associating the value with the foreign currency.

20. The computer-readable storage medium of claim 11, further including converting a value associated with the accounting object from at least one of:
the foreign currency to the home currency; and
the home currency to the foreign currency.

21. An apparatus that automatically associates a foreign currency with an accounting object, the apparatus comprising:
a receiving mechanism configured to receive a name from a user;
a determining mechanism configured to determine an association between the name and the foreign currency, wherein the foreign currency is different from a home currency; and
an associating mechanism configured to automatically associate the accounting object with the foreign currency associated with the name.
